(19) United States
(12) Patent Application Publication
(10) Pub. No.: US 2023/0049935 A1
(43) Pub. Date: Feb. 16, 2023

(54) POWDER METALLURGY (PM) SUPERALLOY WITH HIGH STRENGTH AND PLASTICITY AND PREPARATION METHOD AND USE THEREOF

(71) Applicant: Zhengzhou University of Aeronautics, Zhengzhou (CN)

(72) Inventors: Dejian SUN, Zhengzhou (CN); Jiachen KANG, Zhengzhou (CN); Guizhong Li, Zhengzhou (CN); Ka GAO, Zhengzhou (CN); Zan ZHANG, Zhengzhou (CN); Yang GAO, Zhengzhou (CN); Lei FAN, Zhengzhou (CN); Xiaoqin GUO, Zhengzhou (CN)

(21) Appl. No.: 17/864,207

(22) Filed: Jul. 13, 2022

(30) Foreign Application Priority Data
Aug. 13, 2021 (CN) 202110932669.4

(51) Int. Cl. C22C 19/05; C22C 19/07; C22C 1/04; B22F 3/03

(52) U.S. Cl. CPC C22C 19/056; C22C 19/07; C22C 1/0433; B22F 3/03; B22F 2301/15

(57) ABSTRACT

The present disclosure discloses a preparation method of a powder metallurgy (PM) superalloy with high strength and plasticity. Under the multi-field coupling action of a thermal field and a force field, the PM superalloy is obtained in a high-temperature graphite mold by using the method of conducting heat preservation and oscillating-pressure sintering in two steps. Under the action of a circulating pressure, rearrangement of powders and discharge of pores are promoted, and therefore, the PM superalloy is sintered and formed. The present disclosure further discloses a PM superalloy prepared by using the method above. The PM superalloy has the characteristics of low grade of prior particle boundary defects, uniform grain refinement and high density. The sintered PM superalloy obtained in the present disclosure has a yield strength of 955 MPa, a tensile strength of 1,437 MPa and an elongation of 31.9%, and has high strength and plasticity.

### CROSS REFERENCE TO RELATED APPLICATION

This patent application claims the benefit and priority of Chinese Patent Application No. 202110932669.4, filed on Aug. 13, 2021, the disclosure of which as is incorporated by reference herein in its entirety as part of the present application.

### BACKGROUND

### Related Field

The present disclosure belongs to the field of powder metallurgy (PM) superalloys, and relates to a PM superalloy with high strength and plasticity and a preparation method and use thereof.

### Related Art

At present, nickel-based superalloys have excellent high-temperature strength, great ductility and high fracture toughness. Thus, the nickel-based superalloys have been widely used in hot-end components such as turbine discs of aero-engines. Preparation and processing routes of PM superalloys mainly include: a, direct hot isostatic pressing; b, combination of hot isostatic pressing and isothermal forging; and c, combination of hot isostatic pressing, hot extrusion and isothermal forging. The direct hot isostatic pressing route has a simple process, a short preparation period and a low cost. Therefore, the direct hot isostatic pressing route has become the focus of development in the future. However, at present, since the problem of “cooperative control over structures and defects”, such as grain coarsening and formation of prior particle boundary defects, cannot be effectively solved by using this route, a turbine disc prepared by using this method has a potential safety hazard during service. Therefore, this method has not been widely used.

In order to solve the problems above, the hot extrusion and the isothermal forging are used. Not only are the preparation cost and the process complexity increased, but also a sintered blank has a risk of cracking during hot processing. Due to the problems above, use of the PM superalloys is limited. The key to promote wide use of the direct hot isostatic pressing route in preparation of the PM superalloys is to solve the problem of “control over structures and defects” during sintering. Therefore, in order to solve the problem described above, it is essential to find a preparation method of a high-performance PM superalloy.

### BRIEF SUMMARY

In order to overcome the shortcomings of the prior art, a first objective of the present disclosure is to provide a preparation method of a PM superalloy with high strength and plasticity. The PM superalloy prepared by using this method has the characteristics of low-grade prior particle boundary defects and fine grains.

A second objective of the present disclosure is to provide a PM superalloy with high strength and plasticity.

A third objective of the present disclosure is to provide use of the PM superalloy with high strength and plasticity described above.

The first objective of the present disclosure is implemented by using the following technical solution.

A preparation method of a PM superalloy with high strength and plasticity includes the following steps:

(1) loading a prefabricated powder into a mold, and conducting cold press molding, where, the prefabricated powder consists of the following raw materials by weight percent: 12.0-17.0% of chromium, 7.0-14.0% of cobalt, 3.30-4.20% of tungsten, 0.05-3.50% of niobium, 2.00-3.70% of aluminum, 2.30-3.90% of titanium, 0.02-0.07% of carbon, 0.025-0.070% of zirconium, 0.006-0.020% of boron, 0.50% or less of iron, 0.150% or less of manganese, 0.150% or less of silicon, 0.015% or less of sulfur, 0.015% or less of phosphorus and the balance of nickel;

(2) after the cold press molding in step (1), putting the mold containing the prefabricated powder into an oscillating-pressure sintering furnace, applying a constant pressure P₁ to a sample, and heating the sample; after a sintering temperature T₁ is reached, adjusting the sintering furnace to enter a first heat preservation stage, increasing an oscillating pressure to a median value, and applying the oscillating pressure to the sample; after the first heat preservation stage is completed, conducting heating continuously to reach a sintering temperature T₂, and adjusting the sintering furnace to enter a second heat preservation stage; and applying the oscillating pressure until the second heat preservation stage is completed; and

(3) after the heat preservation is completed, stopping the heating, conducting cooling, reducing the oscillating pressure to a constant pressure P₂ until the cooling is completed, and then obtaining a finished product.

Further, in step (2), sintering is conducted at a heating rate of 8° C./min, the sintering temperature T₁ is 950-1,050° C., the sintering temperature T₂ is 1,100-1,200° C., and the first heat preservation stage and the second heat preservation stage are each conducted for 1-3 h.

Further, in step (2), the oscillating pressure has a median value of 60-100 MPa, an amplitude of ±5 to ±10 MPa and an oscillation frequency of 1-10 Hz.

Further, in step (2) and step (3), the constant pressures P₁ and P₂ are both 5 MPa; and in step (3), the pressure is reduced at a rate of 10 MPa/min.

Further, in step (1), the cold press molding is conducted under a pressure of 10 MPa for 3 min.

Further, in step (1), the prefabricated powder has a particle size of less than 53 μm.

Further, in step (2) and step (3), operations are carried out in a vacuum environment.

The second objective of the present disclosure is implemented by using the following technical solution.

A PM superalloy with high strength and plasticity is prepared by using the method above.

The third objective of the present disclosure is implemented by using the following technical solution.

The PM superalloy with high strength and plasticity is used in a turbine disc of an aero-engine.

Compared with the prior art, the present disclosure has the following beneficial effects.

The present disclosure provides a preparation method of a PM superalloy with high strength and plasticity. Under the multi-field coupling action of a thermal field and a force field, the PM superalloy is obtained in a high-temperature graphite mold by using the method of conducting heat preservation and oscillating-pressure sintering in two steps. Under the action of a circulating pressure, rearrangement of powders and discharge of pores are promoted, and therefore, the PM superalloy is sintered and formed. The present disclosure further provides a PM superalloy prepared by using the method above. The PM superalloy has the characteristics of low grade of prior particle boundary defects, uniform grain refinement and high density. The sintered PM superalloy obtained in the present disclosure has a yield strength of 955 MPa, a tensile strength of 1,437 MPa and an elongation of 31.9%, and has high strength and plasticity. The present disclosure further provides use of the PM superalloy described above in a turbine disc of an aero-engine. The PM superalloy has a great development potential.

### BRIEF DESCRIPTION OF THE DRAWINGS

FIG. 1 is a diagram showing tensile stress-strain curves of PM superalloys prepared in Examples 1 to 3 and Comparative Examples 1 to 3 of the present disclosure at room temperature;

FIG. 2 is a diagram showing microscopic structures of the PM superalloy prepared in Example 1 of the present disclosure; and

FIG. 3 is a diagram showing microscopic structures of the PM superalloy prepared in Comparative Example 1 of the present disclosure.

### DETAILED DESCRIPTION OF VARIOUS EMBODIMENTS

The present disclosure is further described below with reference to the accompanying drawings and specific embodiments. It should be noted that, provided that there is no conflict, new examples may be formed by arbitrarily combining various examples or various technical features described below.

### Example 1

A preparation method of a PM superalloy with high strength and plasticity included the following steps.

(1) A prefabricated powder was loaded into a high-purity graphite pressing mold coated with a boron nitride coating, and cold press molding and pre-press molding were conducted under a pressure of 10 MPa for 3 min to obtain a cylindrical sheet with a diameter of 40 mm and a thickness of 6 mm. The prefabricated powder consisted of the following raw materials by weight percent: 15.0% of chromium, 10.0% of cobalt, 3.50% of tungsten, 1.50% of niobium, 3.00% of aluminum, 3.00% of titanium, 0.05% of carbon, 0.050% of zirconium, 0.010% of boron, 0.10% of iron, 0.100% of manganese, 0.100% of silicon, 0.010% of sulfur, 0.010% of phosphorus and the balance of nickel, and had a particle size of less than 53 μm.

(2) After the cold press molding in step (1), the graphite pressing mold containing the prefabricated powder was put into an oscillating-pressure sintering furnace, a constant pressure of 5 MPa was applied to a sample, and the sample was heated. After 1,000° C. was reached, the sintering furnace was adjusted to enter a first heat preservation stage for heat preservation for 2 h. An oscillating pressure was increased to a median value of 70 MPa, and an oscillating circulating pressure was applied to the sample at an amplitude of ±10 MPa and an oscillation frequency of 5 Hz. After the first heat preservation stage was completed, heating was conducted continuously to reach 1,120° C. at a heating rate of 8° C./min, and the sintering furnace was adjusted to enter a second heat preservation stage for heat preservation for 1 h. The oscillating pressure was applied until the second heat preservation stage was completed.

(3) After the heat preservation was completed, the heating was stopped, cooling was conducted, and the oscillating pressure was changed into a constant pressure of 5 MPa until the cooling was completed. An inner cavity of the sintering furnace was naturally cooled down to room temperature with the furnace, a cavity door was opened by vacuum breaking, a pressure head was slowly removed to reduce the pressure on the graphite mold, and the mold was taken out. Finally, the sample, namely, the PM superalloy with high strength and plasticity, in the mold was obtained.

### Example 2

A preparation method of a PM superalloy with high strength and plasticity included the following steps.

(1) A prefabricated powder was loaded into a high-purity graphite pressing mold coated with a boron nitride coating, and cold press molding and pre-press molding were conducted under a pressure of 10 MPa for 3 min to obtain a cylindrical sheet with a diameter of 40 mm and a thickness of 6 mm. The prefabricated powder consisted of the following raw materials by weight percent: 12.0% of chromium, 7.0% of cobalt, 3.30% of tungsten, 0.05% of niobium, 2.00% of aluminum, 2.30% of titanium, 0.02% of carbon, 0.025% of zirconium, 0.006% of boron, 0.30% of iron, 0.050% of manganese, 0.130% of silicon, 0.012% of sulfur, 0.005% of phosphorus and the balance of nickel, and had a particle size of less than 53 μm.

(2) After the cold press molding in step (1), the graphite pressing mold containing the prefabricated powder was put into an oscillating-pressure sintering furnace, a constant pressure of 5 MPa was applied to a sample, and the sample was heated. After 950° C. was reached, the sintering furnace was adjusted to enter a first heat preservation stage for heat preservation for 3 h. An oscillating pressure was increased to a median value of 70 MPa, and an oscillating circulating pressure was applied to the sample at an amplitude of ±5 MPa and an oscillation frequency of 1 Hz. After the first heat preservation stage was completed, heating was conducted continuously to reach 1,150° C. at a heating rate of 8° C./min, and the sintering furnace was adjusted to enter a second heat preservation stage for heat preservation for 1 h. The oscillating pressure was applied until the second heat preservation stage was completed.

(3) After the heat preservation was completed, the heating was stopped, cooling was conducted, and the oscillating pressure was changed into a constant pressure of 5 MPa until the cooling was completed. An inner cavity of the sintering furnace was naturally cooled down to room temperature with the furnace, a cavity door was opened by vacuum breaking, a pressure head was slowly removed to reduce the pressure on the graphite mold, and the mold was taken out. Finally, the sample, namely, the PM superalloy with high strength and plasticity, in the mold was obtained.

### Example 3

A preparation method of a PM superalloy with high strength and plasticity included the following steps.

(1) A prefabricated powder was loaded into a high-purity graphite pressing mold coated with a boron nitride coating, and cold press molding and pre-press molding were conducted under a pressure of 10 MPa for 3 min to obtain a cylindrical sheet with a diameter of 40 mm and a thickness of 6 mm. The prefabricated powder consisted of the following raw materials by weight percent: 17.0% of chromium, 14.0% of cobalt, 4.20% of tungsten, 3.50% of niobium, 3.70% of aluminum, 3.90% of titanium, 0.07% of carbon, 0.070% of zirconium, 0.020% of boron, 0.20% of iron, 0.050% of manganese, 0.080% of silicon, 0.050% of sulfur, 0.050% of phosphorus and the balance of nickel, and had a particle size of less than 53 μm.

(2) After the cold press molding in step (1), the graphite pressing mold containing the prefabricated powder was put into an oscillating-pressure sintering furnace, a constant pressure of 5 MPa was applied to a sample, and the sample was heated. After 1,050° C. was reached, the sintering furnace was adjusted to enter a first heat preservation stage for heat preservation for 3 h. An oscillating pressure was increased to a median value of 70 MPa, and an oscillating circulating pressure was applied to the sample at an amplitude of ±8 MPa and an oscillation frequency of 10 Hz. After the first heat preservation stage was completed, heating was conducted continuously to reach 1,100° C. at a heating rate of 8° C./min, and the sintering furnace was adjusted to enter a second heat preservation stage for heat preservation for 3 h. The oscillating pressure was applied until the second heat preservation stage was completed.

(3) After the heat preservation was completed, the heating was stopped, cooling was conducted, and the oscillating pressure was changed into a constant pressure of 5 MPa until the cooling was completed. An inner cavity of the sintering furnace was naturally cooled down to room temperature with the furnace, a cavity door was opened by vacuum breaking, a pressure head was slowly removed to reduce the pressure on the graphite mold, and the mold was taken out. Finally, the sample, namely, the PM superalloy with high strength and plasticity, in the mold was obtained.

### Comparative Example 1

Compared with Example 1, Comparative Example 1 had the following differences. In step (3), the processes of conducting heating and heat preservation and applying an oscillating pressure in two stages were changed into a process of conducting constant-pressure sintering in one step. The sintering was conducted at a temperature of 1,120° C. under a constant pressure of 80 MPa, and heat preservation was conducted for 2 h. Other conditions were the same as those in Example 1. Finally, a finished product was obtained.

### Comparative Example 2

Compared with Example 1, Comparative Example 2 had the following differences. In step (3), the processes of conducting heating and heat preservation and applying an oscillating pressure in two stages were changed into a process of conducting constant-pressure sintering in two steps. The sintering temperature T₁ was 1,000° C., and the first heat preservation stage was conducted for 1 h. The sintering temperature T₂ was 1,120° C., and heat preservation was conducted for 1 h. The whole sintering process was conducted under a constant pressure of 80 MPa Other conditions were the same as those in Example 1. Finally, a finished product was obtained.

### Comparative Example 3

Compared with Example 1, Comparative Example 3 had the following differences. In step (3), the processes of conducting heating and heat preservation and applying an oscillating pressure in two stages were changed into a process of conducting oscillating hot-pressing sintering in one step. The sintering was conducted at a temperature of 1,120° C., and heat preservation was conducted for 1 h. An oscillating pressure was applied in the whole sintering process, and had a median value of 70 MPa, an amplitude of 10 MPa and an oscillation frequency of 5 Hz. Other conditions were the same as those in Example 1. Finally, a finished product was obtained.

### Experimental Example

A room-temperature tensile property test, an evaluation of the grade of prior particle boundary defects and a density test were carried out on the finished products obtained in Examples 1 to 3 and Comparative Examples 1 to 3 of the present disclosure.

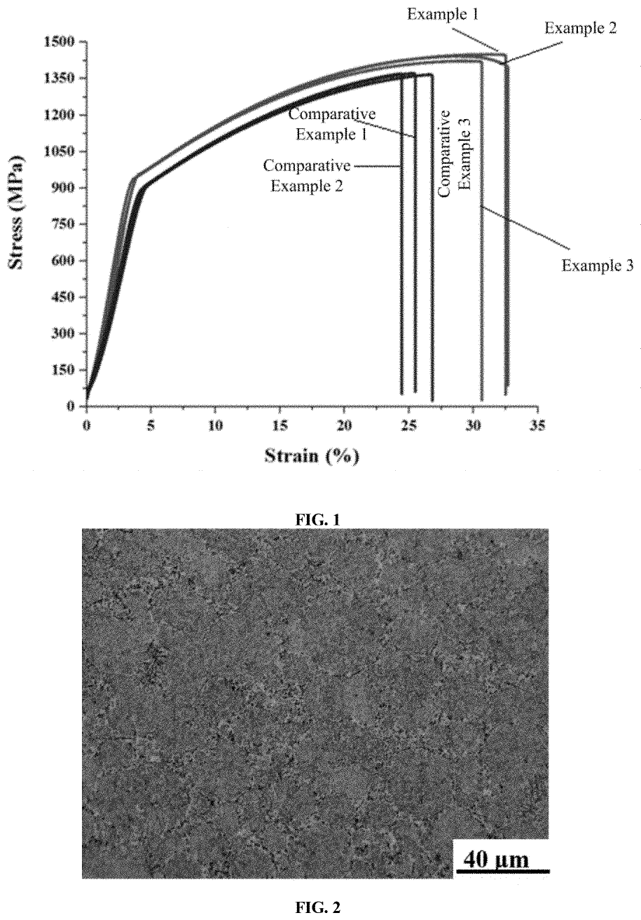

The room-temperature tensile property test was carried out on the finished products obtained in Examples 1 to 3 and Comparative Examples 1 to 3 by using a universal testing machine, and results were shown in FIG. 1. The samples in Examples 1 to 3 had an average yield strength of 955 MPa, an average tensile strength of 1,437 MPa and an average elongation of 31.9%. The samples in Comparative Examples 1 to 3 had an average yield strength of 902 MPa, an average tensile strength of 1,370 MPa and an average elongation of 25.6%. From the results above, it could be seen that by using the method of conducting heat preservation and oscillating-pressure sintering in two steps in the present disclosure, the strength and plasticity of the PM superalloy could be significantly improved.

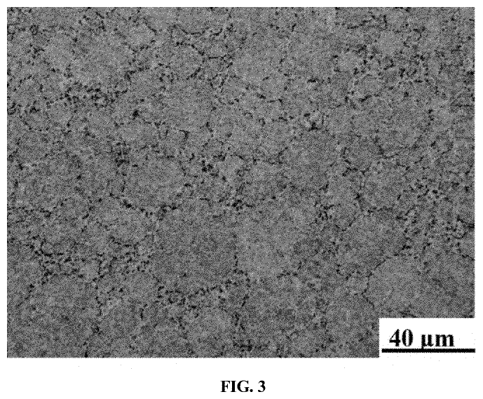

The evaluation of the grade of prior particle boundary defects was carried out on the finished products obtained in Example 1 and Comparative Example 1 of the present disclosure. Before the evaluation, corrosion treatment was required to be conducted on the samples. Results were shown in FIG. 2 and FIG. 3. The sample obtained by conducting constant-pressure sintering in one step had many prior particle boundary defects with clear circular or nearly circular powder boundaries. However, the sample obtained by conducting heat preservation and oscillating-pressure sintering in two steps in the present disclosure had few prior particle boundary defects. Therefore, it could be seen that by using the preparation method of the present disclosure, the grade of the prior particle boundary defects could be effectively reduced.

According to results of the density test, it was shown that the samples obtained in Examples 1 to 3 of the present disclosure had a density of 99.5% or above. Complete densification was basically achieved, and sintering was conducted at high temperature for a short time.

In summary, the PM superalloy prepared by using the preparation method of a PM superalloy with high strength and plasticity provided in the present disclosure has a density of 99.5% or above. Complete densification is basically achieved, and sintering is conducted at high temperature for a short time. The PM superalloy has few prior particle boundary defects and uniform grain refinement. The PM superalloy has great strength and plasticity, and can be used in a turbine disc of an aero-engine.

The embodiments described above are merely preferred embodiments of the present disclosure, and are not intended to limit the protection scope of the present disclosure. Any nonessential modifications and substitutions made by those skilled in the art on the basis of the present disclosure fall within the protection scope of the present disclosure.

What is claimed is:

1. A preparation method of a powder metallurgy (PM) superalloy with high strength and plasticity, the method comprising the following steps:
(1) loading a prefabricated powder into a mold, and conducting cold press molding, wherein, the prefabricated powder consists of the following raw materials by weight percent: 12.0-17.0% of chromium, 7.0-14.0% of cobalt, 3.30-4.20% of tungsten, 0.05-3.50% of niobium, 2.00-3.70% of aluminum, 2.30-3.90% of titanium, 0.02-0.07% of carbon, 0.025-0.070% of zirconium, 0.006-0.020% of boron, 0.50% or less of iron, 0.150% or less of manganese, 0.150% or less of silicon, 0.015% or less of sulfur, 0.015% or less of phosphorus and the balance of nickel;
(2) after the cold press molding in step (1), putting the mold containing the prefabricated powder into an oscillating-pressure sintering furnace, applying a constant pressure P₁ to a sample, and heating the sample; after a sintering temperature T₁ is reached, adjusting the sintering furnace to enter a first heat preservation stage, increasing an oscillating pressure to a median value, and applying the oscillating pressure to the sample; after the first heat preservation stage is completed, conducting heating continuously to reach a sintering temperature T₂, and adjusting the sintering furnace to enter a second heat preservation stage; and applying the oscillating pressure until the second heat preservation stage is completed; and
(3) after the heat preservation is completed, stopping the heating, conducting cooling, reducing the oscillating pressure to a constant pressure P₂ until the cooling is completed, and then obtaining a finished product.

2. The preparation method of a PM superalloy with high strength and plasticity according to claim 1, wherein, in step (2), sintering is conducted at a heating rate of 8° C./min, the sintering temperature T₁ is 950-1,050° C., the sintering temperature T₂ is 1,100-1,200° C., and the first heat preservation stage and the second heat preservation stage are each conducted for 1-3 h.

3. The preparation method of a PM superalloy with high strength and plasticity according to claim 1, wherein, in step (2), the oscillating pressure has a median value of 60-100 MPa, an amplitude of ±5 to ±10 MPa and an oscillation frequency of 1-10 Hz.

4. The preparation method of a PM superalloy with high strength and plasticity according to claim 1, wherein, in step (2) and step (3), the constant pressures P₁ and P₂ are both 5 MPa; and in step (3), the pressure is reduced at a rate of 10 MPa/min.

5. The preparation method of a PM superalloy with high strength and plasticity according to claim 1, wherein, in step (1), the cold press molding is conducted under a pressure of 10 MPa for 3 min.

6. The preparation method of a PM superalloy with high strength and plasticity according to claim 1, wherein, in step (1), the prefabricated powder has a particle size of less than 53 μm.

7. The preparation method of a PM superalloy with high strength and plasticity according to claim 1, wherein, in step (2) and step (3), operations are carried out in a vacuum environment.

8. A PM superalloy with high strength and plasticity, prepared by using the method according to claim 1.

9. The PM superalloy with high strength and plasticity according to claim 8, wherein, in step (2), sintering is conducted at a heating rate of 8° C./min, the sintering temperature T₁ is 950-1,050° C., the sintering temperature T₂ is 1,100-1,200° C., and the first heat preservation stage and the second heat preservation stage are each conducted for 1-3 h.

10. The PM superalloy with high strength and plasticity according to claim 8, wherein, in step (2), the oscillating pressure has a median value of 60-100 MPa, an amplitude of ±5 to ±10 MPa and an oscillation frequency of 1-10 Hz.

11. The PM superalloy with high strength and plasticity according to claim 8, wherein, in step (2) and step (3), the constant pressures P₁ and P₂ are both 5 MPa; and in step (3), the pressure is reduced at a rate of 10 MPa/min.

12. The PM superalloy with high strength and plasticity according to claim 8, wherein, in step (1), the cold press molding is conducted under a pressure of 10 MPa for 3 min.

13. The PM superalloy with high strength and plasticity according to claim 8, wherein, in step (1), the prefabricated powder has a particle size of less than 53 μm.

14. The PM superalloy with high strength and plasticity according to claim 8, wherein, in step (2) and step (3), operations are carried out in a vacuum environment.

15. Use of the PM superalloy with high strength and plasticity according to claim 8 in a turbine disc of an aero-engine.

16. The use according to claim 15, wherein, in step (2), sintering is conducted at a heating rate of 8° C./min, the sintering temperature T₁ is 950-1,050° C., the sintering temperature T₂ is 1,100-1,200° C., and the first heat preservation stage and the second heat preservation stage are each conducted for 1-3 h.

17. The use according to claim 15, wherein, in step (2), the oscillating pressure has a median value of 60-100 MPa, an amplitude of ±5 to ±10 MPa and an oscillation frequency of 1-10 Hz.

18. The use according to claim 15, wherein, in step (2) and step (3), the constant pressures P₁ and P₂ are both 5 MPa; and in step (3), the pressure is reduced at a rate of 10 MPa/min.

19. The use according to claim 15, wherein, in step (1), the cold press molding is conducted under a pressure of 10 MPa for 3 min.

20. The use according to claim 15, wherein, in step (1), the prefabricated powder has a particle size of less than 53 μm.
